(19) United States
(12) Patent Application Publication
(10) Pub. No.: US 2019/0343153 A1
(43) Pub. Date: Nov. 14, 2019

(54) JUICE PRODUCTS AND METHODS FOR REDUCED ENZYMATIC BROWNING

(71) Applicant: The Coca-Cola Company, Atlanta, GA (US)

(72) Inventors: Theresa K. MATTINGLY, Mount Dora, FL (US); Marcelo PEREZ, Bradenton, FL (US)

(73) Assignee: The Coca-Cola Company, Atlanta, GA (US)

(21) Appl. No.: 16/099,410

(22) PCT Filed: May 5, 2017
(86) PCT No.: PCT/US2017/031257

§ 371 Date: Nov. 6, 2018

Related U.S. Application Data
(60) Provisional application No. 62/332,915, filed on May 6, 2016.

(51) Int. Cl. A23L 2/44; A23L 2/02; A23L 5/41

(52) U.S. Cl. CPC A23L 2/44; A23V 2002/00; A23L 5/41; A23L 2/02

(57) ABSTRACT

Juice products and associated methods are provided that include a fruit or vegetable juice having one or more polyphenols, and an anti-browning agent that includes acerola in an amount effective to reduce oxidation of the one or more polyphenols by polyphenol oxidase (PPO). For example, the disclosed method can include providing a juice having one or more polyphenols, in which the juice is a fruit or vegetable juice, and adding an anti-browning agent to the juice, in which the anti-browning agent includes acerola in an amount effective to inhibit oxidation of the one or more polyphenols by polyphenol oxidase (PPO).

### CROSS REFERENCE TO RELATED APPLICATIONS

This application claims the benefit of priority to U.S. Provisional Patent No. 62/332,915, filed on May 6, 2016, and is a U.S.C. § 371 national stage application of PCT Patent Application No. PCT/US2017/031257, filed May 5, 2017, each of which is incorporated herein by reference in its entirety.

### TECHNICAL FIELD

This disclosure relates to juice products having reduced enzymatic browning, and methods for reducing enzymatic browning.

### BACKGROUND

Fruit and vegetables have health benefits for consumers, due to their content of fiber, vitamins, and antioxidant compounds. However, during harvesting, preparation (for example, cutting fruit for fresh-cut fruits), and storage of these fruits and vegetables, the antioxidant compounds undergo many changes. These changes often induce a pronounced loss of the microbiological and antioxidant qualities. Thus, preservation against oxidation in food during processing and storage has become an increasing priority in the food industry.

Enzymatic browning is one of the main oxidative reactions which occurs in food, and is one of the most important reactions which occurs in fruits and vegetables. Enzymatic browning usually resulting in negative effects on color, taste, flavor, and nutritional value. This reaction is largely a consequence of the phenolic compounds' oxidation by polyphenol oxidase (PPO), which triggers the generation of dark pigments, thus creating change in the color of the food (for example, browning). Enzymatic browning of fruits and vegetables juices reduces consumer appeal and acceptability, thus making enzymatic browning one of the most pressing problems in the juice industry.

Various approaches to reducing enzymatic browning have been explored.

Traditional methods of inhibiting enzymatic browning in fruits and vegetables include heat treatments such as through the use of hot water, steam, or air, all of which create an undesirable loss of flavor and nutrients. Other approaches include the addition of chemical anti-browning agents such as ascorbic acid, sorbic acid, benzoic acid, and styrene. However, while these conventional chemical anti-browning agents can be effective, they are generally synthetic and are not used in their natural form. The addition of these synthetic anti-browning ingredients may be undesirable to some consumers, who desire “natural” or “all-natural” beverage products.

Therefore, there is a continuing need to provide juice products with natural anti-browning agents, for example, anti-browning agents that are not synthetic or do not contain added flavors or colors, that effectively reduce the rate of enzymatic browning of the fruit and/or vegetables within the juice products. It is also desirable to maintain the aesthetic and/or nutritional properties of the fruits and/or vegetables when the juice products are combined with natural anti-browning agents.

### SUMMARY

This disclosure provides generally new juice products having reduced enzymatic browning and methods for reducing enzymatic browning. The juice products and associated methods include the combination of juices with natural anti-browning agents which surprisingly maintain suitable aesthetic and/or nutritional properties of the juice products. It has now been unexpectedly discovered that by employing acerola as an anti-browning agent within a juice product, a reduction in enzymatic browning can be achieved. It has also been unexpectedly discovered that utilizing acerola also provides sustainability of the aesthetic and nutritional properties of the juice product. The disclosed methods and products provide the improved ability to use fruits and vegetables ingredients in juices and juice products. The present methods are suitable for use in both ripe and unripe fruit and vegetables.

According to one aspect, for example, this disclosure provides a juice product comprising:
a fruit or vegetable juice comprising one or more polyphenols; and
an anti-browning agent comprising acerola in an amount effective to reduce oxidation of the one or more polyphenols by polyphenol oxidase (PPO).

In a further aspect, for example, this disclosure provides a method for reducing enzymatic browning of a juice product, the method comprising:
providing a juice comprising one or more polyphenols, wherein the juice is a fruit or vegetable juice; and
adding an anti-browning agent to the juice, the anti-browning agent comprising acerola in an amount effective to inhibit oxidation of the one or more polyphenols by polyphenol oxidase (PPO).

These and various other aspects and embodiments of this disclosure are illustrated in the drawings, examples, data, and detailed description that follow.

### BRIEF DESCRIPTION OF THE DRAWINGS

FIG. 1 graphically illustrates the test results from the comparative UV/VIS absorption analysis in Example 3.

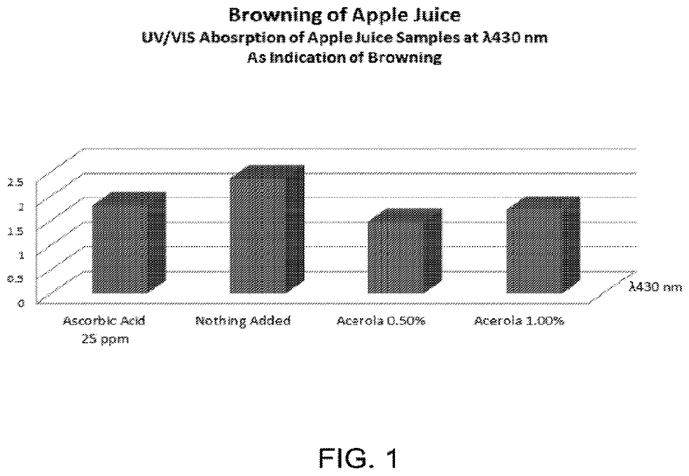

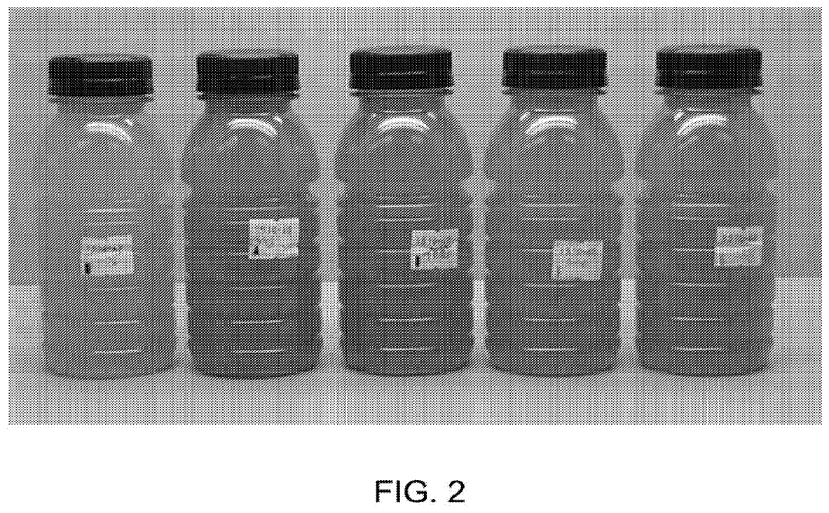

FIG. 2 provides photographs of various samples of juice products that were tested for enzymatic browning in the Examples. In order (from left to right) are:
Control Sample (ascorbic acid added, maintained at −70° F.);
Untreated Juice Sample (60A), maintained at ambient temperature;
Ascorbic Acid Treated Juice Sample (60B), ambient temperature;
Acerola Treated Juice Sample at 0.50% (60F), ambient temperature; and
Acerola Treated Juice Sample at 1.00% (60G), ambient temperature.

### DETAILED DESCRIPTION

Aspects of this disclosure provide for new juice products, methods, and compositions which reduce enzymatic browning of certain juice products containing the compositions. This disclosure further provides for juice products that include an anti-browning agent which increases shelf-life while also decreasing any undesirable impact on the aesthetic and/or nutritional properties of the fruits and/or vegetables of the juice.

In one aspect, the disclosure provides for a juice product comprising a fruit or vegetable juice comprising one or more polyphenols and an anti-browning agent. The anti-browning agent comprises acerola in an amount effective to reduce oxidation of the one or more polyphenols by polyphenol oxidase (“PPO”).

In instances where the juice comprises a fruit juice, the fruit juice may be substantially derived from one or more fruits, in which the one or more fruits include ripe fruits, unripe fruits, or a combination thereof. Non-limiting examples of suitable fruits include plums, prunes, dates, currants, figs, grapes, red grapes, sweet potatoes, raisins, cranberries, pineapples, peaches, bananas, apples, peas, guavas, apricots, Saskatoon berries, blueberries, plains berries, prairie berries, mulberries, elderberries, choke cherries, coconuts, olives, raspberries, strawberries, huckleberries, loganberries, currants, dewberries, boysenberries, kiwi, cherries, blackberries, quinces, buckthorns, passion fruits, sloes, rowans, gooseberries, pomegranates, persimmons, mangos, rhubarbs, papayas, lychees, cashew apples, lemons, oranges, limes, tangerines, mandarin oranges, tangelos, pomelos, grapefruits, tomatoes, tomatillos, Kiwano melon, casaba melons, choke berries, watermelons, cantaloupes, honeydew melons, prickly pears, guanabanas (soursops), nectarines, tamarinds, ugli fruits, tangelos, wesos, yumberry, crabapples, carambolas (star fruits), marion berries, lingonberries (cowberries), young berries, dewberries, dalandans, calamansis, aloe, yuzus, mangosteens, huito fruits, durians, rambutans, dragon fruits, cherimoyas, goji berries, acais, Mexian hawthorns, feijoas, jackfruits, Jabuticabas, camu-camus, kumquats, yuganzis, citrons, lulos (Naranjilla, kabosus), hornworts, natsumikans, palm fruits, and the like, and combinations thereof. Alternatively, some juices may be extracted from leaves, for instance extracts from mint leaves can provide a spearmint or peppermint taste.

In instances where the juice comprises a vegetable juice, the vegetable juice may be substantially derived from one or more vegetables, in which the one or more vegetables include ripe vegetables, unripe vegetables, or a combination thereof. Non-limiting examples of suitable vegetables include carrots, spinach, peppers, cabbage, sprouts, broccoli, potatoes, celery, anise (fennel), cucumbers, parsley, cilantro, beets, wheat grass, asparagus, zucchini, squash, rhubarb, turnips, rutabagas, parsnips, radishes, watercress, endive, escarole, lettuce, spinach, garlic, onion, ginger, carrots, yellow carrots, purple/black carrots, spinach, peppers, cabbage, red cabbage, sprouts, broccoli, potatoes, celery, anise (fennel), cucumbers, parsley, cilantro, beets, wheat grass, asparagus, zucchini, squash, rhubarb, turnips, rutabagas, parsnips, radishes, watercress, endive, escarole, lettuce, spinach, garlic, onion, ginger, artichokes, chicory, kohlrabi, yucca, collard greens, eggplant, green beans, mustard greens, summer squash, butternut squash, spaghetti squash, zucchini, peppermint, spearmint, curcumin, annatto, and the like, and combinations thereof. In addition, any one or more of the disclosed fruit juices and any one or more of the disclosed vegetable juices can be combined if desired and used according to this disclosure.

In certain instances, the fruit or vegetable juice is substantially derived from one or more fruits and one or more vegetables, respectively, by pressing. In some embodiments, juice blends are prepared from at least one fruit juice and at least one vegetable juice. Generally, fruits and vegetables are typically washed, stemmed, blanched, and then crushed, ground, or milled followed by mashing and enzyme treatment with heat. The enzyme-treated fruits or vegetables are then decanted as purée or pressed into juice. In some instances, the fruits or vegetables are treated to reduce turbidity either by centrifugation or enzyme treatment followed by ultrafiltration or flocculation/filtration. Once turbidity is reduced, the juice is decanted or pressed.

In some instances, the juice product may also include secondary water (that is, water that is separate and apart from any water that is naturally or normally present in the fruit or vegetable juice), which may typically be the vehicle or primary liquid portion in which the remaining ingredients of the juice products are dissolved, emulsified, suspended, or dispersed. In certain aspects, purified water may be used in the manufacture of the juice products disclosed herein, and water of a standard juice product quality can be employed in order not to adversely affect taste, odor, or appearance. The water typically will be clear, colorless, free from objectionable minerals, tastes and odors, free from organic matter, low in alkalinity and of acceptable microbiological quality based on industry and government standards applicable at the time of producing the juice product. In one aspect, secondary water is present at a level of from about 0% to about 35% by weight of the juice product. In certain instances, the water used in the juice products disclosed herein can be “treated water,” which refers to water that has been treated to reduce the total dissolved solids of the water prior to optional supplementation, for example, with calcium as disclosed in U.S. Pat. No. 7,052,725, which is hereby incorporated by reference herein in its entirety. Methods of producing treated water are known to those of ordinary skill in the art and include deionization, distillation, filtration, and reverse osmosis (“r-o”), among others. The terms “treated water,” “purified water,”, “demineralized water,” “distilled water,” and “r-o water” are understood to be generally synonymous in this discussion, referring to water from which substantially all mineral content has been removed, typically containing no more than about 500 ppm total dissolved solids, for example, about 250 ppm total dissolved solids.

It should be understood that juice products in accordance with the present disclosure may have any of numerous different specific formulations or constitutions. The juice products disclosed herein may contain additional ingredients, including, generally, any of those typically found in beverage formulations. The formulation of a juice product in accordance with this disclosure can vary to a certain extent, depending upon such factors as the product's intended market segment, its desired nutritional characteristics, flavor profile, and the like.

Non-limiting examples of suitable additional ingredients include, sweeteners, flavorings, electrolytes, vitamins, fruit or vegetable products (other than juice), tastants, preservatives, pH adjusting agents, enzymes, weighting agents, solvents, fruit or vegetable pulp, fruit and vegetable pieces, essential oils, masking agents and the like, flavor enhancers, color agents or dyes, antifoaming agents, gums, emulsifiers, cloud components, mineral and non-mineral nutritional supplements, antioxidants, purifiers, and/or carbonation, which typically can be added to any such juice products to vary the taste, mouthfeel, nutritional characteristics, etc.

It should be further noted that in certain instances, the present juice products undergo post-treatments. Non-limiting examples of suitable post-treatments include de-aeration, blanching, or addition of chemical agents for pH alteration such as citric, malic, or phosphoric acids, via addition of synthetic chelating agents such as EDTA, or via addition of synthetic sulfites or reducing agents or antioxidants, for example, ethoxyquin, BHA, BHT, polyphenols, or tocopherols.

In some aspects, the acerola is in the form of a purée, for example, paste. As used herein the term “purée” is defined as a concentrate having an apparent viscosity from about 200 cps to about 10,000 cps measured at temperature of 25° C. The purée may be unfrozen raw purée, frozen purée, or thawed purée.

Generally, acerola purée can be prepared from the edible portion of pressed or macerated sound, wholesome, and appropriately mature fruit of freshly harvested or fresh frozen acerola cherries (Malpighia glabra, M. punicifolia, M. emarginata). As a result, acerola purée may have a higher pulp content as compared to aqueous liquid extracted from the same acerola cherries.

In some instances, pulp can be present in the acerola purée at a concentration of about 25 wt. % to about 95 wt. %; alternatively, from about 55 wt. % to about wt. 90%; or alternatively, from about 60 wt. % to about 85 wt. % based on weight of the acerola purée. According to another aspect, the pulp can be present in the acerola purée at a concentration of about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. %, about 89 wt. %, about 90 wt. %, about 91 wt. %, about 92 wt. %, about 93 wt. %, about 94 wt. %, or about 95 wt. % based on weight of the acerola purée. The pulp also can be present at a concentration range between any of these recited concentrations.

In other aspects, the acerola is in a non-purée form, for example, powder or liquid. For example, in one aspect, the acerola is in the form of an aqueous liquid expressed or extracted from one or more acerola cherries. In certain aspects, the acerola may be cooked, while in other aspects, the acerola may be uncooked.

In some instances, the anti-browning agent can be present in the juice product at a concentration of about 0.5 wt. % to about 5 wt. %; alternatively of about 0.5 wt. % to about 2 wt. %; or alternatively, of about 0.5 wt. % to about 1 wt. % based on weight of the juice product. According to another aspect, the anti-browning agent can be present at a concentration of about 0.51 wt. %, about 0.52 wt. %, about 0.53 wt. %, about 0.54 wt. %, about 0.55 wt. %, about 0.56 wt. %, about 0.57 wt. %, about 0.58 wt. %, about 0.59 wt. %, about 0.60 wt %, about 0.61 wt. %, about 0.62 wt. %, about 0.63 wt. %, about 0.64 wt. %, about 0.65 wt. %, about 0.66 wt. %, about 0.67 wt. %, about 0.68 wt. %, about 0.69 wt. %, about 0.70 wt %, about 0.71 wt. %, about 0.72 wt. %, about 0.73 wt. %, about 0.74 wt. %, about 0.75 wt. %, about 0.76 wt. %, about 0.77 wt. %, about 0.78 wt. %, about 0.79 wt. %, about 0.80 wt %, about 0.81 wt. %, about 0.82 wt. %, about 0.83 wt. %, about 0.84 wt. %, about 0.85 wt. %, about 0.86 wt. %, about 0.87 wt. %, about 0.88 wt. %, about 0.79 wt. %, about 0.90 wt. %, about 0.91 wt. %, about 0.92 wt. %, about 0.93 wt. %, about 0.94 wt. %, about 0.95 wt. %, about 0.96 wt. %, about 0.97 wt. %, about 0.98 wt. %, about 0.99 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3.0 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4.0 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, or about 5 wt. % based on weight of the juice product. The anti-browning agent also can be present at a concentration range between any of these recited concentrations.

In certain aspects, the effectiveness of the anti-browning agent disclosed herein may be determined quantitatively by measuring the absorbance value of the test juice product having a certain anti-browning agent at a wavelength of about 430 nm and comparing the value with the 430 nm absorbance of a control sample. For example, the control sample may be the same juice having a different anti-browning agent, no added anti-browning agent, or even a different concentration of the same anti-browning agent. Generally, the comparison is made between separate portions taken from the same juice sample, where each portion has a different treatment. This allows a direct comparison between each sample's 430 nm absorbance value. Color absorption at about 430 nm is universally accepted as an indication of enzymatic browning in fruits and vegetables. It is understood that higher absorption values at this wavelength indicate a higher degree of enzymatic browning.

In some aspects, an apple juice containing about 1.0 wt % of acerola purée as described herein, after being maintained at a temperature from about 70° C. to about 80° C. for twenty-six weeks, may have an absorbance value at a wavelength of 430 nm of about 1.8 or less. Alternatively, after being maintained at a temperature from about 70° C. to about 80° C. for twenty-six weeks, an apple juice containing 1.0 wt % of acerola purée may have an absorbance value at a wavelength of 430 nm of about 1.7 or less, about 1.6 or less, about 1.5 or less, about 1.4 or less, about 1.3 or less, about 1.2 or less, about 1.1 or less, or about 1.0 or less. An apple juice containing about 0.5 wt % of acerola purée as described herein, after being maintained at a temperature from about 70° C. to about 80° C. for twenty-six weeks, may have an absorbance value at a wavelength of 430 nm of about 1.5 or less. Alternatively, after being maintained at a temperature from about 70° C. to about 80° C. for twenty-six weeks, an apple juice containing 0.5 wt % of acerola purée may have an absorbance value at a wavelength of 430 nm of about 1.4 or less, about 1.3 or less, about 1.2 or less, about 1.1 or less, or about 1.0 or less.

In another aspect, after being maintained at a temperature from about 70° C. to about 80° C. for twenty-six weeks, the absorbance value at a wavelength of 430 nm of the juice product having from about 1.0 to about 0.5 wt % of acerola purée may be from about 1.4 to about 1.8. Alternatively, the absorbance value at a wavelength of 430 nm of the juice product having from about 1.0 to about 0.5 wt % of acerola purée may be about 0.9, about 1.0, about 1.1, about 1.2, about 1.3, about 1.4, about 1.5, about 1.6, about 1.7, about 1.8, or about 1.9.

As used herein, a “comparative” juice product is simply a control sample of the subject juice product that is substantially the same in composition as the test sample juice product, for example, taken from the same batch as the test sample juice product, except that the control juice product has a different anti-browning agent treatment than the test sample. The control juice product (control sample) and the test sample (containing acerola) are usually derived from dividing the same original fruit or vegetable juice sample. Acerola is then included in the test sample, whereas a different anti-browning agent or no anti-browning agent at all is included in the control juice product as a control. Thus, in an aspect, the control juice product does not comprise any anti-browning agent. In some aspects, the control comprises a conventional anti-browning agent, such as ascorbic acid, sorbic acid, benzoic acid, and styrene. In some aspects, the control comprises a different concentration of the same anti-browning agent as the test sample. In some aspects, the control can comprise the same anti-browning treatment but is measured at a different time from the test sample, or under different temperature conditions, and the like. Similarly, the term “comparative” absorbance value is used herein to refer to the absorbance value of a “control juice product” (control sample), that is measured under the same conditions and parameters as the measured absorbance value of the juice product (test sample) in accordance with the present disclosure.

Because these control or “comparative” samples will be characterized by some difference in anti-browning agent treatments, such as differences in chemical composition, concentration, sample storage or maintenance conditions (temperature, time, and the like), or the presence of an added anti-browning agent, the performance differences between control and test samples based on these different anti-browning agent treatments can be quantified. In an aspect, the effectiveness of the anti-browning agent disclosed herein may be determined quantitatively by determining the total color difference (ΔE) between different juices or juice products having different anti-browning agent treatments.

In one aspect, after being maintained at a temperature from about 70° C. to about 80° C. for twenty-six weeks, the juice product comprising acerola may have a total color difference (ΔE) of about 1.8 or less when compared with a control sample. Alternatively, when maintained at a temperature from about 70° C. to about 80° C. for twenty-six weeks, the juice product also may have a total color difference (ΔE) of about 5.0 or less, about 4.9 or less, about 4.8 or less, about 4.7 or less, about 4.6 or less, about 4.5 or less, about 4.4 or less, about 4.3 or less, about 4.2 or less, about 4.1 or less, about 4.0 or less, about 3.9 or less, about 3.8 or less, about 3.7 or less, about 3.6 or less, about 3.5 or less, about 3.4 or less, about 3.3 or less, about 3.2 or less, about 3.1 or less, about 3.0 or less, about 2.9 or less, about 2.8 or less, about 2.7 or less, about 2.6 or less, about 2.5 or less, about 2.4 or less, about 2.3 or less, about 2.2 or less, about 2.1 or less, about 2.0 or less, about 1.9 or less, about 1.8 or less, about 1.7 or less, about 1.6 or less, about 1.5 or less, about 1.4 or less, about 1.3 or less, about 1.2 or less, about 1.1 or less, about 1.0 or less, about 0.9 or less, about 0.8 or less, about 0.7 or less, about 0.6 or less, about 0.5 or less, about 0.4 or less, about 0.3 or less, about 0.2 or less, or about 0.1 or less. The juice product also may have a total color difference (ΔE) in a range between any of these recited ΔE values. For example and not as a limitation, the control sample can be maintained at low temperature (−70° F.) for the same time as the test sample and can include ascorbic acid as an anti-browning treatment.

In other aspects, after being maintained at a temperature from about 70° C. to about 80° C. for twenty-six weeks, the test juice product may have a total color difference (ΔE) that is up to or about 45% less than a total color difference (ΔE′) of a control juice product. The total color difference ΔE or ΔE is the change in color from the start of the test (time=0) to the end of the test (time=26 weeks, for example), for the test sample or the control sample, respectively. Thus, the “comparative total color difference” is a total color difference of the control juice product versus the control juice product at the end of the test period, that is ΔE-AE, where the control juice product is subjected to the same experimental conditions (for example, storage time, temperature, light conditions) and measured under the same conditions as the test juice product. That is, the difference between samples is the anti-browning treatment in the samples. Alternatively, when maintained at a temperature from about 70° C. to about 80° C. for twenty-six weeks, the juice product also may have a total color difference (ΔE) up to or about 55% less, up to or about 50% less, up to or about 45% less, up to or about 40% less, up to or about 35% less, up to or about 30% less, up to or about 25% less, up to or about 20% less, up to or about 15% less, up to or about 10% less, or up to or about 5% less than a total color difference (ΔE′) of a control juice product. The comparative total color difference is therefore ΔE′-AE, which is equivalent to the difference in colors of the control sample and the test sample at the end of the test period.

In one aspect, under the conditions of being maintained at a temperature from about 70° C. to about 80° C. for twenty-six weeks, the test juice product may have a total color difference (ΔE) of about 1.0 to about 5.0 and a control juice product may have a total color difference (ΔE′) of about 5.5 to about 10.0. Alternatively, when maintained at a temperature from about 70° C. to about 80° C. for twenty-six weeks, the test juice product may have a total color difference (ΔE) of about 5.0 or less and a control juice product may have a total color difference (ΔE′) that is greater than the total color difference (ΔE) of the test juice product.

As used herein total color difference of the test sample, or (ΔE), according to a CIE L*a*b* (CIELAB) color analysis, is defined by the following formula:

ΔE=[(ΔL*)²+(Δa*)²+(Δb*)²]^{1/2}

wherein:
ΔL* is the total difference in lightness/darkness value;
Δa* is the total difference in ratio of green to red; and
Δb* is the total difference in ratio of yellow to blue,
in which the total difference in value or ratio is between the value or ratio of the juice product and the value or ratio of a reference sample. For example, the reference sample may be maintained at conditions to mimic a freshly-made beverage.

As used herein total color difference of the control sample or (ΔE′), according to a CIE L*a*b* (CIELAB) color analysis, is defined by the following formula:

ΔE′=[ΔL*)²+(Δa*)²+(Δb*)²]^{1/2}

wherein:
ΔL* is the total difference in lightness/darkness value;
Δa* is the total difference in ratio of green to red; and
Δb* is the total difference in ratio of yellow to blue,
in which the total difference in value or ratio is between the value or ratio of control juice product which has been subjected to the same experimental conditions (for example, storage time, temperature) and the value or the reference sample.

As used herein “total hue difference” or (ΔH or ΔH′) as applied to the test or control sample, according to a CIE L*C*h (CIELCh) color analysis, is defined by the following formula:

ΔH*=[(ΔE)²−(ΔL*)²−(ΔC*)²]^{1/2}

wherein:
ΔL* is the total difference in lightness/darkness value based on the CIELAB scale;
ΔE is the total color difference according to the CIELAB scale, as described above; and
ΔC* is the total difference in chroma, wherein C* is calculated using the following formula:

C*=[(a*)²(b*)²]^{1/2}
wherein:
   a* is ratio of green to red according to the CIELAB scale (−a is green, +a is red); and
   b* is the ratio of yellow to blue according to the CIELAB scale (+b is yellow, and −b is blue)
in which the total difference in value or ratio is between the value or ratio of the juice product and the value or ratio of a reference sample.

### EXAMPLES

Ninety pounds of size 88 Trent Golden Delicious apples (about 200 fruits) were washed and rinsed. After the apples were washed and rinsed, they were ground, and then subsequently juiced using a Good Nature X-1 Single Layer Press with EG 260 Variable Speed Grinder.

The Good Nature X-1 Single Layer Press with EG 260 Variable Speed Grinder was equipped with ½″ stainless steel grinder discs and press racks were placed on the front and back posts of the hopper. A medium weave white cloth press bag was inserted between the press on back and front posts. The EG 260 grinder was turned on and the speed was gradually increased to maintain 60 Hz. (2875 rpm). The washed and rinsed apples were dropped into the end of the hopper chute and a produce feeder was used to gently push the apples down the hopper chute and through the grinder. The resulting ground apples were collected in the medium weave white cloth press bag. After the grinding was complete, the medium weave white cloth press bag was removed from the stems on the grinder and hung from the stationary platen in the “press” position of a Good Nature X-1 Single Layer Press. The press was powered on, and the flow control valve was gradually adjusted so that the pressure on the pressure gauge of the press increased from 0 to 1800 psi, yielding approximately 44 psi of pressure on the apples. The resulting juice from the apples was collected in the juice tray and transferred to a 5-gallon receptacle.

The extracted apple juice was divided into sample subsets and treated as described in Table 1 below:

TABLE 1
Anti-Browning Treatment of Samples

| | Anti-Browning | Concentration of |
|---|---|---|
| Sample | Agent | Agent in Juice |
| 60A and 60A′ | None | 0 |
| (Ambient Temp) | | |
| 60B and 60B′ | Ascorbic Acid* | 25 ppm |
| (Ambient Temp) | | |
| 60D | Lemon Purée*** | 5,000 ppm |
| (Ambient Temp) | | (0.5% w/w) |
| 60E | Lemon Purée*** | 10,000 ppm |
| (Ambient Temp) | | (1.0% w/w) |
| 60F and 60F′ | Acerola Purée** | 5,000 ppm |
| (Ambient Temp) | | (0.5% w/w) |
| 60G and 60G′ | Acerola Purée** | 10,000 ppm |
| (Ambient Temp) | | (1.0% w/w) |
| Control A and Control B | Ascorbic Acid* | 25 ppm |
| (−70° F.) | | |

*Fine granular synthetic L-ascorbic acid CAS No.: 50-81 (L-threo-hex-2-enoic acid γ-lactone; 3-oxo-L-gulofuranolactone)-7), sourced from DSM Nutritional Products, Inc.
**100% natural 7 brix frozen single strength acerola cherry purée (Malphighia punicifoli L.), sourced from Niagro Nichirei Do Brasil Agricola LTDA.
***Not From Concentrate Juice with 9 brix with 5.8% acidity, sourced from Ventura Coastal.

The samples were then hot filled into 8-ounce PET bottles at 210° Fahrenheit for 22 seconds and then cooled to 185° Fahrenheit before being added to an ambient temperature (70° F.) water bath. Four different samples, 60A, 60B, 60F, and 60G, as set out above, were stored for 26 weeks at ambient temperatures (70-80° F.). Six different samples, 60A′, 60B′, 60D, 60E, 60F′, and 60G′, as set forth above, were stored for 14 weeks at ambient temperatures (70-80° F.).

Samples Control A and Control B were each treated with ascorbic acid and were stored for 26 weeks at −70° F. to inhibit enzymatic browning, such that a sample derived from the same starting material was prepared and maintained in its initial production state for purposes of comparative testing. Thus, the Control A and Control B samples were prepared in such a manner such that their physical properties could be treated as representative of, or as a proxy for, the behavior of a juice sample immediately after production in analytical evaluations. Following storage, each control sample was brought to ambient temperature (70-80° F.).

Following a 26-week storage, the samples, 60A, 60B, 60F, 60G, and Control A were analyzed at ambient temperature (70-80° F.) as discussed below in Examples 1 and 3-5.

Following a 14-week storage, the samples, 60A′, 60B′, 60D, 60E, 60F′, 60G′, and Control B were analyzed at ambient temperature (70-80° F.) as discussed below in Example 2.

### Example 1: Instrumental Color Analysis for 26-Week Storage Samples

An internal CIE L*a*b* color analysis and an internal CIE L*C*h° (CIELCh) color analysis of each sample was determined using a conventional X-rite Gretag-Macbeth Color i5 Tristimulus Colorimeter. Samples 60A, 60B, 60F, 60G, and Control A were poured into #9825 Pyrex 200 MM test tubes and placed in the X-rite juice tube holder attached to the Large Area of View (LAV) Aperture plate, and the color for each sample was measured using the X-rite Colorimeter with Xenon, D65 illuminant in reflectance mode.

CIE refers to the International Commission on Illumination and the L*a*b* values are measured according to international standard method ISO 10526. The CIE L*, a*, and b* values were derived using Color X-rite IQC Basic version 6.00.45 software. On the L*a*b* plane, values can be interpreted as follows:
+L white, −L black
a is green, +a is red
+b is yellow, and −b is blue
Delta L* (ΔL*) is the total difference in lightness/darkness of the sample including opacity.
Delta a* (Δa*) is the total difference in ratio of green to red.
Delta b* (Δb*) is the total difference in ratio of yellow to blue.
Delta E (ΔE) is the total difference in color (including opacity) which is defined above.
   On the L*C*h° plane, values can be interpreted as follows:
Delta h (Δh) is the total difference in the hue angle.
Delta H (ΔH) is the total difference in hue only; excluding opacity, which is defined above.

The following Delta E (ΔE) values and their respective visual meanings in the below table are generally considered universal qualitative descriptions for interpreting each quantitative ΔE value.

TABLE 2
Visual Characterization of Delta (ΔE) Values

| Delta E (ΔE) | |
|---|---|
| Value | Visual Meaning |
| 0-1 | A normally invisible difference |
| 1-2 | Very small difference to a trained eye |
| 2-3.5 | Medium difference to both trained and untrained eyes |
| 3.5-5 | An obvious difference to both trained and untrained |
| | eyes |

Sources: (1) Delta E, Delta H, Delta T: What Does It Mean? (accessed at http://help.efi.com/fieryxf/KnowledgeBase/color/Delta%20E_H_T.pdf); (2) Delta E | Color Difference Algorithms (accessed at http://zschuessler.github.io/DeltaE/learn/)

The table below summarizes the results of the instrumental color analyses of each sample. Each delta value (ΔL*, Δa*, Δb*, ΔE, and ΔH) was calculated as the total difference between the values of the test sample and the control sample, where the control sample was the reference sample.

TABLE 3
Color Characterization of the Test Juice Samples with Acerola Purée vs. the Low
Temperature Control Juice Sample with Ascorbic Acid at 26-Week Storage

| Sample | L* | a* | b* | ΔL* | Δa* | Δb* | ΔE | Δh | ΔH |
|---|---|---|---|---|---|---|---|---|---|
| Control A | 31.02 | −0.05 | 3.28 | | | | | | |
| (−70° F.) | | | | | | | | | |
| 60A | 31.87 | 0.8 | 8.47 | 0.85 | 0.85 | 5.19 | 5.33 | −0.28 | 27.91 |
| 60B | 28.61 | 0.97 | 6.76 | −2.41 | 1.02 | 3.48 | 4.35 | −0.42 | 22.4 |
| 60F | 28.84 | 0.47 | 7.16 | −2.18 | 0.52 | 3.88 | 4.48 | −0.21 | 23.53 |
| 60G | 29.74 | 0.19 | 6.68 | −1.28 | 0.24 | 3.4 | 3.64 | −0.12 | 21.92 |

The results of Table 3 indicate that, for all acerola treated juice samples 60F and 60G, the total color difference ΔE was 4.48 and 3.64. These total color difference ΔE values are comparable to the total color difference ΔE of sample 60B, which was treated with ascorbic acid as an anti-browning agent and had a ΔE of 4.35. The untreated juice sample 60A had a ΔE value of 5.33 as compared to the low temperature Control A sample. As such, acerola-treated juice samples had up to about 32% reduction in enzymatic browning as compared to the untreated sample (60A). 1.0% acerola treated sample 60G even had a 16% reduction in enzymatic browning from the ambient temperature ascorbic acid-treated sample 60B. It can be seen that acerola as the anti-browning agent is surprisingly effective in inhibiting enzymatic browning. These results indicate that 0.5% acerola purée is comparably effective as an anti-browning agent to 25 ppm ascorbic acid, and that 1.0% acerola puree is even more effective at reducing enzymatic browning than 25 ppm ascorbic acid. Without being bound to a single theory, it is believed that acerola inhibits the production of quinones, which would darken the juice.

A similar calculation using the same data compares the color characterization of the test juice samples having different anti-browning treatments with the 60A sample being used as the control sample. That is, all these comparisons were conducted at ambient temperature, comparing the ascorbic acid-containing sample 60B and the acerola-containing samples 60F and 60G, to the sample containing no added anti-browning treatment (60A), all samples being at ambient temperature. Table 4 below summarizes the instrumental color analysis results, again calculating ΔL*, Δa*, Δb*, ΔE, Δh, and ΔH comparing each test samples to the same control sample 60A.

TABLE 4
Color Characterization of the Test Juice Samples vs. the Ambient
Temperature Control Juice Sample having no Anti-browning
Treatment at 26-Week Storage

| Sample | L* | a* | b* | ΔL* | Δa* | Δb* | ΔE | Δh | ΔH |
|---|---|---|---|---|---|---|---|---|---|
| 60A | 31.87 | 0.8 | 8.47 | | | | | | |
| (Con- | | | | | | | | | |
| trol) | | | | | | | | | |
| 60B | 28.61 | 0.97 | 6.76 | −3.26 | −0.17 | −1.7 | 3.68 | 0.56 | 58.1 |
| 60F | 28.84 | 0.47 | 7.16 | −3.03 | −0.33 | −1.3 | 3.31 | 0.27 | 61.0 |
| 60G | 29.74 | 0.19 | 6.68 | −2.13 | −0.61 | −1.8 | 2.85 | 0.38 | 56.9 |

The results of Table 4 indicate that, under the same temperature conditions, the acerola treated juice samples 60F and 60G showed a total color difference ΔE that was below 3.4, as compared to the untreated sample at ambient temperature, and the ascorbic acid treated juice sample 60B showed a total color difference ΔE that was below 3.7, as compared to the untreated sample at ambient temperature.

### Example 2: Instrumental Color Analysis for 14-Week Storage Samples

The internal CIE L*a*b* color analysis as set forth in Example 1 was also performed on the 14-Week Storage Samples.

The table below summarizes the results of the instrumental color analysis of each sample. Each delta value (ΔL*, Δa*, Δb*, and ΔE) was calculated as the total difference between the values of the test sample and the control sample, where the control sample was the reference sample.

TABLE 5
Color Characterization of the Test Juice Samples vs. the
Low Temperature Control Juice Sample with Ascorbic
Acid at 14-Week Storage

| Sample | L* | a* | b* | ΔL* | Δa* | Δb* | ΔE |
|---|---|---|---|---|---|---|---|
| Control B | 30.99 | −0.55 | 4.29 | | | | |
| (−70° F.) | | | | | | | |
| 60A′ | 32.84 | 0.22 | 6.56 | 1.85 | 0.77 | 1.85 | 2.73 |
| 60B′ | 29.16 | 0.46 | 6.05 | −1.83 | 1.01 | −1.83 | 2.78 |
| 60D | 28.95 | 0.73 | 5.85 | −2.04 | 1.28 | −2.04 | 3.16 |
| 60E | 29.41 | 0.71 | 6.12 | −1.58 | 1.26 | −1.58 | 2.57 |
| 60F′ | 29.23 | −0.12 | 5.42 | −1.76 | 0.43 | −1.76 | 2.53 |
| 60G′ | 29.65 | −0.34 | 5.83 | −1.34 | 0.21 | −1.34 | 1.91 |

The results of Table 5 indicate that for all acerola-treated juice samples 60F′ and 60G′, the total color difference ΔE was 2.53 and 1.91, respectively, as compared to the Control B sample. The lemon-treated juice samples 60D and 60E had a ΔE value of 3.16 and 2.57, respectively, as compared to the Control B sample. In comparing acerola-treated juice samples and lemon-treated juice samples, acerola as the anti-browning agent is more effective for inhibiting enzymatic browning. Specifically, the acerola-treated juice sample at 0.5% had up to about 20% reduction in enzymatic browning compared to the lemon-treated juice sample at 0.5%. Similarly, the acerola-treated juice sample at 1.0% had up to about 26% reduction in enzymatic browning compared to the lemon treated juice sample at 1.0%. Surprisingly, these results show that, even though acerola and lemon have the same pH-reducing capabilities, acerola is more effective as an anti-browning agent.

Further, the untreated juice sample 60A′ had a ΔE value of 2.73 as compared to the Control B sample. As such, acerola-treated juice samples had up to about 30% reduction in enzymatic browning as compared to the untreated sample. 1.0% Acerola-treated sample 60G′ even had a 31% reduction in enzymatic browning from the low temperature ascorbic acid sample 60B′.

A similar calculation using the same data compares the color characterization of the test juice samples having different anti-browning treatments with the 60A′ sample being used as the control sample. That is, all these comparisons were conducted at ambient temperature, comparing the ascorbic acid-containing sample 60B′, the lemon-containing samples 60D and 60E, and the acerola-containing samples 60F and 60G′, to the sample containing no added anti-browning treatment (60A′), all samples being at ambient temperature. Table 6 below summarizes the instrumental color analysis results, again calculating ΔL*, Δa*, Δb*, and ΔE comparing each test samples to the same control sample.

TABLE 6
Color Characterization of the Test Juice Samples vs. the
Ambient Temperature Control Juice Sample having no
Anti-Browning Treatment at 14-Week Storage

| Sample | L* | a* | b* | ΔL* | Δa* | Δb* | ΔE |
|---|---|---|---|---|---|---|---|
| 60A′ | 32.84 | 0.22 | 6.56 | | | | |
| (Control) | | | | | | | |
| 60B′ | 29.16 | 0.46 | 6.05 | −3.68 | 0.24 | −0.51 | 3.72 |
| 60D | 28.95 | 0.73 | 5.85 | −3.89 | 0.51 | −0.71 | 3.99 |
| 60E | 29.41 | 0.71 | 6.12 | −3.43 | 0.49 | −0.44 | 3.49 |
| 60F′ | 29.23 | −0.12 | 5.42 | −3.61 | −0.34 | −1.14 | 3.80 |
| 60G′ | 29.65 | −0.34 | 5.83 | −3.19 | −0.56 | −0.73 | 3.32 |

The results of Table 6 indicate that under the same temperature conditions, the acerola treated juice samples 60F and 60G′ showed a total color difference ΔE that was 3.8 or below, as compared to the untreated sample at ambient temperature. The lemon-treated juice samples 60D and 60E showed a total color difference Δ* that was below 4, as compared to the untreated sample at ambient temperature. The ascorbic acid-treated juice samples 60B′ showed a total color difference ΔE that was below 3.8, as compared to sample 60A′ at ambient temperature.

### Example 3: UV/VIS Spectrophotometric Absorption Analysis for 26-Week Storage Samples

Each test sample, with no dilution, was tested for UV/VIS absorption at a wavelength of 430 nm using a Spectronic Genesys 5 UV/VIS spectrophotometer. The table below summarizes the absorbance values at 430 nm of each tested sample.

TABLE 7
Measured Absorbance Values

| Sample | Absorbance Value |
|---|---|
| 60A | 2.37 |
| 60B | 1.81 |
| 60F | 1.48 |
| 60G | 1.72 |

As shown in the above table, the untreated juice sample 60A was found to have the highest absorbance value (2.37) at 430 nm, while the acerola-treated juice samples 60F and 60G each had lower absorbance values, 1.48 and 1.72, respectively. Compared to the untreated juice sample, the acerola-treated juice samples had a 27% reduction and a 40% reduction, respectively, in enzymatic browning. As such, this indicates that incorporating acerola as an anti-browning agent is effective in reducing enzymatic browning. Additionally, compared to the ascorbic acid-treated sample 60B, each acerola-treated juice sample had a lower absorbance value, thereby demonstrating that acerola is more effective in reducing enzymatic browning.

### Example 4: Visual Analysis for 26-Week Storage Samples

A visual analysis was performed to compare the qualitative appearance of the test samples to the appearance of the control sample. The degree of visual difference between the test samples and the control sample was determined by a panel of five chemists using the following scale for appearance:

| | |
|---|---|
| 0-1 | SIMILAR TO CONTROL |
| 2-4 | ACCEPTABLE |
| 5-7 | NOTICEABLE DIFFERENCE |
| 8-9 | NOT SIMILAR |

Each chemist evaluated the samples individually and a group discussion occurred after each test sample evaluation to determine a group consensus on the final rating. The results of the visual evaluation are listed in the below table. Scores for each sample were collected and averaged into the final rating.

TABLE 8
Results of the Appearance Evaluation

| | | | | Appearance | |
|---|---|---|---|---|---|
| Sam- | | Use | | Degree of | |
| ple | Treatment | Level | Storage | Difference | Comments |
| 60A | Untreated - | | Ambient | 8 (Not | Different, |
| | Nothing Added | | 70-80° F. | Similar) | Off |
| | to Protect Color | | | | |
| 60B | Ascorbic Acid | 25 | Ambient | 8 (Not | Different, |
| | Added to | ppm | 70-80° F. | Similar) | Off |
| | Protect Color | | | | |
| 60F | Acerola Purée | 0.5% | Ambient | 5 (Noticeable | Noticeable |
| | | | 70-80° F. | Difference) | difference |
| | | | | | still |
| | | | | | acceptable |
| 60G | Acerola Purée | 1.0% | Ambient | 5 (Noticeable | Noticeable |
| | | | 70-80° F. | Difference) | difference |
| | | | | | still |
| | | | | | acceptable |

The results shown in Table 8 indicate that the hue of the acerola-treated juice samples remained consistent after the 26-week ambient storage, thereby demonstrating that the presence of acerola maintains the aesthetic properties of the juice sample and reduces and/or slows enzymatic browning of the juice, which in turn also substantially protects the production color of the juice sample. Additionally, as compared to ascorbic acid treatment, acerola is shown to be more effective in maintaining the production color of the juice, and therefore inhibiting enzymatic browning.

The disclosures of various publications may be referenced throughout this specification, which are hereby incorporated by reference in pertinent part in order to more fully describe the state of the art to which the disclosed subject matter pertains. To the extent that any definition or usage provided by any document incorporated herein by reference conflicts with the definition or usage provided herein, the definition or usage provided herein controls.

Throughout the specification and claims, the word “comprise” and variations of the word, such as “comprising” and “comprises,” means “including but not limited to,” and is not intended to exclude, for example, other additives, components, elements, or steps. While methods and features are described in terms of “comprising” various steps or components, these methods and features can also “consist essentially of” or “consist of” the various steps or components.

Unless indicated otherwise, when a range of any type is disclosed or claimed, for example a range of the percentages, total color differences, concentrations, weights, and the like, it is intended to disclose or claim individually each possible number that such a range could reasonably encompass, including any sub-ranges or combinations of sub-ranges encompassed therein. When describing a range of measurements such as these, every possible number that such a range could reasonably encompass can, for example, refer to values within the range with one significant figure more than is present in the end points of a range, or refer to values within the range with the same number of significant figures as the end point with the most significant figures, as the context indicates or permits. For example, when describing a range of percentages such as from 85% to 95%, it is understood that this disclosure is intended to encompass each of 85%, 86%, 87%, 88%, 89%, 90%, 91%, 92%, 93%, 94%, and 95%, as well as any ranges, sub-ranges, and combinations of sub-ranges encompassed therein. Applicants' intent is that these two methods of describing the range are interchangeable. Accordingly, Applicants reserve the right to proviso out or exclude any individual members of any such group, including any sub-ranges or combinations of sub-ranges within the group, if for any reason Applicants choose to claim less than the full measure of the disclosure, for example, to account for a reference that Applicants are unaware of at the time of the filing of the application.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed herein, and that each value is also herein disclosed as “about” that particular value in addition to the value itself. In aspects, “about” can be used to mean within 10% of the recited value, within 5% of the recited value, or within 2% of the recited value.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

In any application before the United States Patent and Trademark Office, the Abstract of this application is provided for the purpose of satisfying the requirements of 37 C.F.R. § 1.72 and the purpose stated in 37 C.F.R. § 1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that are employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

Those skilled in the art will readily appreciate that many modifications are possible in the exemplary embodiments disclosed herein without materially departing from the novel teachings and advantages according to this disclosure. Accordingly, all such modifications and equivalents are intended to be included within the scope of this disclosure as defined in the following claims. Therefore, it is to be understood that resort can be had to various other aspects, embodiments, modifications, and equivalents thereof which, after reading the description herein, may suggest themselves to one of ordinary skill in the art without departing from the spirit of the present disclosure or the scope of the appended claims.

Applicants reserve the right to proviso out any selection, feature, range, element, or aspect, for example, to limit the scope of any claim to account for a prior disclosure of which Applicants may be unaware.

The following numbered embodiments, aspects, and features of the disclosure are provided, with an emphasis on the ability to combine the various features which may disclosed only in certain embodiments, into other disclosed embodiments, as the context and technical reason allow.

### Embodiments

1. A juice product comprising:
a fruit or vegetable juice comprising one or more polyphenols; and an anti-browning agent comprising acerola in an amount effective to reduce oxidation of the one or more polyphenols by polyphenol oxidase (PPO).
2. The juice product according to embodiment 1, wherein the acerola is acerola purée.
3. The juice product according to embodiment 1 and 2, wherein the anti-browning agent is present in the juice product at a concentration of about 0.5 wt. % to about 5 wt. % based on weight of the juice product.
4. The juice product according to embodiment 1 and 2, wherein the anti-browning agent is present in the juice product at a concentration of about 0.5 wt. % to about 2 wt. % based on weight of the juice product.
5. The juice product according to embodiment 1 and 2, wherein the anti-browning agent is present in the juice product at a concentration of about 0.5 wt. % to about 1 wt. % based on weight of the juice product.
6. The juice product according to any preceding embodiment, wherein, after being maintained at a temperature from about 70° C. to about 80° C. for twenty-six weeks, the juice product has a total color difference (ΔE) of about 1.8 or less.
7. The juice product according to any preceding embodiment, wherein, after being maintained at a temperature from about 70° C. to about 80° C. for twenty-six weeks, the juice product has a total color difference (ΔE) that is up to or about 45% less than a total color difference (ΔE′) of a control juice product that does not comprise the anti-browning agent.
8. A method for reducing enzymatic browning of a juice product, the method comprising:
providing a juice comprising one or more polyphenols, wherein the juice is a fruit or vegetable juice; and
adding an anti-browning agent to the juice, the anti-browning agent comprising acerola in an amount effective to inhibit oxidation of the one or more polyphenols by polyphenol oxidase (PPO).
9. The method according to embodiment 8, wherein the juice is the fruit juice, and the step of providing the juice comprises deriving the juice from one or more fruits.
10. The method according to embodiment 8, wherein the juice is the vegetable juice, and the step of providing the juice comprises deriving the juice from one or more vegetables.
11. The method according to embodiments 8-10, wherein the acerola is acerola purée.
12. The method according to embodiments 8-11, wherein the anti-browning agent is present in the juice product at a concentration of about 0.5 wt. % to about 5 wt. % based on weight of the juice product.
13. The method according to embodiments 8-11, wherein the anti-browning agent is present in the juice product at a concentration of about 0.5 wt. % to about 2 wt. % based on weight of the juice product.
14. The method according to embodiments 8-11, wherein the anti-browning agent is present in the juice product at a concentration of about 0.5 wt. % to about 1 wt. % based on weight of the juice product.
15. The method according to embodiments 8-14, wherein, after being maintained at a temperature from about 70° C. to about 80° C. for twenty-six weeks, the juice product has a total color difference (ΔE) of about 1.8 or less.
16. The method according to embodiments 8-15, wherein, after being maintained at a temperature from about 70° C. to about 80° C. for twenty-six weeks, the juice product has a total color difference (ΔE) that is up to or about 45% less than a total color difference (ΔE′) of a control juice product that does not comprise the anti-browning agent.

1. A juice product comprising:
a fruit or vegetable juice comprising one or more polyphenols; and
an anti-browning agent comprising acerola in an amount effective to reduce oxidation of the one or more polyphenols by polyphenol oxidase (PPO).

2. The juice product according to claim 1, wherein the acerola is acerola purée.

3. The juice product according to claim 1, wherein the anti-browning agent is present in the juice product at a concentration of about 0.5 wt. % to about 5 wt. % based on weight of the juice product.

4. The juice product according to claim 1, wherein the anti-browning agent is present in the juice product at a concentration of about 0.5 wt. % to about 2 wt. % based on weight of the juice product.

5. The juice product according to claim 1, wherein the anti-browning agent is present in the juice product at a concentration of about 0.5 wt. % to about 1 wt. % based on weight of the juice product.

6. The juice product according to claim 1, wherein, after being maintained at a temperature from about 70° C. to about 80° C. for twenty-six weeks, the juice product has a total color difference (ΔE) of about 1.8 or less.

7. The juice product according to claim 1, wherein, after being maintained at a temperature from about 70° C. to about 80° C. for twenty-six weeks, the juice product has a total color difference (ΔE) that is up to or about 45% less than a total color difference (ΔE′) of a control juice product that does not comprise the anti-browning agent.

8. A method for reducing enzymatic browning of a juice product, the method comprising:
providing a juice comprising one or more polyphenols, wherein the juice is a fruit or vegetable juice; and
adding an anti-browning agent to the juice, the anti-browning agent comprising acerola in an amount effective to inhibit oxidation of the one or more polyphenols by polyphenol oxidase (PPO).

9. The method according to claim 8, wherein the juice is the fruit juice, and the step of providing the juice comprises deriving the juice from one or more fruits.

10. The method according to claim 8, wherein the juice is the vegetable juice, and the step of providing the juice comprises deriving the juice from one or more vegetables.

11. The method according to claim 8, wherein the acerola is acerola purée.

12. The method according to claim 8, wherein the anti-browning agent is present in the juice product at a concentration of about 0.5 wt. % to about 5 wt. % based on weight of the juice product.

13. The method according to claim 8, wherein the anti-browning agent is present in the juice product at a concentration of about 0.5 wt. % to about 2 wt. % based on weight of the juice product.

14. The method according to claim 8, wherein the anti-browning agent is present in the juice product at a concentration of about 0.5 wt. % to about 1 wt. % based on weight of the juice product.

15. The method according to claim 8, wherein, after being maintained at a temperature from about 70° C. to about 80° C. for twenty-six weeks, the juice product has a total color difference (ΔE) of about 1.8 or less.

16. The method according to claim 8, wherein, after being maintained at a temperature from about 70° C. to about 80° C. for twenty-six weeks, the juice product has a total color difference (ΔE) that is up to or about 45% less than a total color difference (ΔE′) of a control juice product that does not comprise the anti-browning agent.
